(19) United States
(12) Patent Application Publication
(10) Pub. No.: US 2016/0030850 A1
(43) Pub. Date: Feb. 4, 2016

(54) SYSTEM AND METHOD FOR MULTIPLAYER FISHING GAME WITH CASTING INTERFACE

(71) Applicant: World Fishing Champions, LLC, North Richland Hills, TX (US)

(72) Inventor: Matthew Sophos, Lake Balboa, CA (US)

(21) Appl. No.: 14/814,357

(22) Filed: Jul. 30, 2015

Related U.S. Application Data
(60) Provisional application No. 62/031,073, filed on Jul. 30, 2014.
(60) Provisional application No. 62/031,078, filed on Jul. 30, 2014.
(60) Provisional application No. 62/031,088, filed on Jul. 30, 2014.

(51) Int. Cl. A63F 13/818; A63F 13/35

(52) U.S. Cl. CPC A63F 13/818; A63F 13/35

(57) ABSTRACT

A multiplayer fishing game with a casting interface, comprising a processor and a user interface device coupled to the processor and configured to generate user-selectable controls in response to data received from the processor. A casting user interface operating on the user interface device and the processor, the casting user interface having a first indicator for selecting a casting power and a second indicator for selecting a casting accuracy. The casting user interface is configured to allow a user to activate a control a first time to stop a dynamic feature of the casting user interface to select the casting power and to activate the control a second time to stop the dynamic feature of the casting user interface to select the casting accuracy.

### RELATED APPLICATIONS

The present application claims priority to and benefit of U.S. Provisional Application No. 62/031,073, filed on Jul. 30, 2014; U.S. Provisional Application No. 62/031,078, filed on Jul. 30, 2014; and U.S. Provisional Application No. 62/031,088, filed on Jul. 30, 2014, each of which is hereby incorporated by reference for all purposes as if set forth herein in its entirety.

### TECHNICAL FIELD

The present disclosure relates generally to fishing games, and more specifically to a system and method for a multiplayer fishing game with a casting interface.

### BACKGROUND OF THE INVENTION

Fishing games typically focus on a single player, and model the fishing experience as a game of chance. Such games fail to capture the aspects of fishing that make it an enjoyable sporting activity.

### SUMMARY OF THE INVENTION

A multiplayer fishing game with a casting interface is disclosed that includes a processor and a user interface device coupled to the processor that is configured to generate user-selectable controls in response to data received from the processor. A casting user interface operating on the user interface device and the processor has a first indicator for selecting a casting power and a second indicator for selecting a casting accuracy. The casting user interface is configured to allow a user to activate a control a first time to stop a dynamic feature of the casting user interface to select the casting power and to activate the control a second time to stop the dynamic feature of the casting user interface to select the casting accuracy.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for managing a multiplayer fishing game, in accordance with an exemplary embodiment of the present disclosure;

FIG. 2 is a diagram of a system for modeling fishing equipment in accordance with an exemplary embodiment of the present disclosure;

FIG. 3 is a diagram of a user interface for a fish finder display, in accordance with an exemplary embodiment of the present disclosure;

FIG. 4 is a diagram of a user interface for casting in accordance with an exemplary embodiment of the present disclosure;

FIG. 5 is a diagram of a lure display, in accordance with an exemplary embodiment the present disclosure;

FIG. 6 is a diagram of a user interface for use with a fish fight, in accordance with an exemplary embodiment of the present disclosure; and

FIG. 7 is a diagram of an algorithm for simulating fish artificial intelligence in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

FIG. 1 is a diagram of a system 100 for managing a multiplayer fishing game, in accordance with an exemplary embodiment of the present disclosure. System 100 can be implemented in hardware or a suitable combination of hardware and software, and can be one or more software systems operating on one or more processing platforms.

System 100 includes fishing game manager 102, user account system 104, equipment model system 106, fish model system 108, lake model system 110, fish finder system 112, tournament system 114, casting system 116, fish fight system 118, lure retrieval system 120, hazard system 122, user interface systems 120A through 124N and tournament sponsor system 126.

Fishing game manager 102 provides user interface functionality, social networking, stores for purchasing game items, a bank for allowing users to exchange real currency for game currency, and other suitable functionality. In one exemplary embodiment, fishing game manager 102 allows a user to create and clothe an avatar, send messages to other players, create and edit a friends list, request technical assistance or to otherwise interact with the game.

User account system 104 allows system 100 and individual users to access user parameters for a plurality of individual user accounts. In one exemplary embodiment, user account system 104 can be implemented as a database or other suitable data storage structures that are configured to store data defining the user equipment associated with the user account, a user avatar, a user credit balance, a user experience rating and other suitable user-specific information for each user account. A user can also select an avatar that will be used to simulate the user within a game environment, to equip the avatar with clothing, hats, sunglasses or other suitable apparel, and to perform other suitable functions related to the avatar.

Equipment model system 106 provides parametric models for different types of equipment used in the fishing game. In one exemplary embodiment, equipment model system 106 can include equipment models that are optimized for certain fishing conditions, for different types of fish, or for other suitable environmental variables. In this exemplary embodiment, a user can participate in fishing events at different locations, where each location has associated fish types, water parameters (clear or cloudy, brown or green color), water hazards (grass, rocks, submerged trees) and other parameters, where different types of equipment are optimized for these different parameters. Likewise, the time of day, weather and other environmental parameters can also have an effect on to selection of optimal equipment. Equipment model system 106 allows the user to select equipment to be used within system 100 in response to these different parametric values.

Fish model system 108 includes artificial intelligence (AI) parametric models for one or more types of fish that are used in the fishing game. In one exemplary embodiment, each fish AI model can have the following parameters:

strike zone—the area around the fish where it can strike a lure

lure preferences—the types of lures or bait that the fish is likely to strike at, including associated strike probabilities for a type of lure, associated strike probabilities for an associated brightness level of a lure, and other parameters

location preferences—the types of habitats that the fish is likely to be located in and associated probabilities, such as in the open, in grass, near underwater objects (and the associated separation distance in feet/meters)

noise preferences—whether the fish is attracted to noise or retreats from noise

speed preference—whether the fish is attracted to fast or slow moving lures and associate probabilities

hunger—the hunger level of a fish, where a low hunger level reduces the probability of a strike and where a high hunger level increases the probability of a strike

aggression—the aggression level of a fish, where an aggressive fish has better fighting characteristics (more energy, more tactics)

time of day—the likelihood of fish to strike as a function of time of day can be modeled, where some times of day can have increased chances and other times of day can have decreased chances associated with different types of fish.

barometric pressure—the likelihood of fish to strike as a function of absolute barometric pressure or changes in barometric pressure can be modeled, where some levels or changes can have increased chances and other levels or changes can have decreased chances associated with different types of fish.

wind—the likelihood of fish to strike as a function of wind or changes in wind can be modeled, where some levels or changes can have increased chances and other levels or changes can have decreased chances associated with different types of fish.

sunlight/clouds the likelihood of fish to strike as a function of sunlight/cloud cover or changes in sunlight/cloud cover can be modeled, where some levels or changes can have increased chances and other levels or changes can have decreased chances associated with different types of fish.

season—the likelihood of fish to strike as a function of the season can be modeled, where some seasons can have increased chances and other seasons can have decreased chances associated with different types of fish.

water temperature—the likelihood of fish to strike as a function of water temperature or changes in water temperature can be modeled, where some levels or changes can have increased chances and other levels or changes can have decreased chances associated with different types of fish.

weather conditions—the likelihood of fish to strike as a function of weather conditions or changes in weather conditions can be modeled, where some conditions or changes can have increased chances and other conditions or changes can have decreased chances associated with different types of fish.

water clarity—the likelihood of fish to strike as a function of water clarity or changes in water clarity can be modeled, where some levels or changes can have increased chances and other levels or changes can have decreased chances associated with different types of fish.

Fish model system 108 stores and updates the fish AI models for each fish that is modeled in the game in each mode of play (steady state, casting, fighting). In one exemplary embodiment, the fish AI models can be set at initiation, and remain unchanged until a player approaches the fish or begins to interact with the fish by generating noise, by casting near the fish or in other suitable manners. During a casting event or a fight, the probabilities for a fish striking a lure, becoming unhooked, using a tactic or otherwise interacting with a user can be suitably combined, such as by addition or multiplication, and applied to other game parameters are discussed herein. In another exemplary embodiment, one or more user interface controls can be generated to allow an administrator to adjust probabilities for a range associated with a type of fish (such as to increase or decrease their range sensitivity to detect a lure or bait), to adjust probabilities associated with a type of lure or bait (such as to increase or decrease the chance of getting a strike on the lure), to adjust the distance or area associated with a fish (such as to increase or decrease the area or distance within which a fish will strike a lure or bait), or other suitable variables.

Lake model system 110 includes image data and maps associated with lakes, such as to model the depth of the lake, locations of fish within the lake, water hazards within the lake, trees, bushes and other suitable data. In one exemplary embodiment, a user can select a lake for a fishing game, the lake can be assigned based on a tournament or other suitable processes can also or alternatively be used to determine the lake. In addition, the location at which the user launches their boat into the water, the distance from the launch point to fishing locations, and other parameters can factor into a user's decision on which lake to fish at and where to enter the lake. For example, the user can be given a predetermined amount of energy that is spent for various activities within the game, including driving to an optimal boat ramp, traveling on the lake from a current fishing spot to a new fishing spot, to cast, reel, hook and land a fish (fishing sequence), to try to untangle a snagged lure or to take other actions than can be strategic factors in the game. For each fishing spot, the locations, heights and diameters of trees and bushes can be modeled, in order to generate a probability of a fish being present in any given spot, a probability of a line getting snagged if the user casts in the vicinity of a tree or bush and other suitable probabilities. For example, if a user targets a cast for a location that is two feet away from a tree that has a ten foot branch radius and branches that start four feet above the water, and the user selects a casting style that results in a high arc, then the probability of getting snagged can be higher than if the user selects a target that is not near any trees, bushes or other hazards, or if the user selects a casting style that is lower to the water. The data for generating the user interface and for calculating snag probabilities as a function of a selected target can be stored in lake model system 110, can be generically applied for all lakes or other fishing locations, or can be implemented in other suitable manners. Lake model system 110 can also generate the user interface for the lake, such as by determining a location of a user on a map of a lake, by determining the features that will be displayed to the user in that location from the map data and associated distance data, and by generating feature objects in the user interface overlay of actual lake images, where the size of the feature objects is adjusted to model the effects of distance (closer objects larger, farther objects smaller), and in other suitable manners. In one exemplary embodiment, a 2D image can be mapped onto a 3D modeled surface, where the camera's range of motion and field of view is adjusted to provide limited motion, giving the illusion that the player is in a 3D environment. In this exemplary embodiment, a user can select a location for a boat on a map or other suitable image using a user interface device, such as a computer mouse. The selection point coordinates are mapped to map or image coordinates, and a camera image associated with the selected map or image coordinates are adjusted within a predetermined boundary to map the 2D image onto a 3D modeled surface associated with the coordinates, in conjunction with high dynamic range imaging (HDRI) photographic image data. In this manner, perspective control is provided in real time that is a function of the user action, with real-time rendering of these effects in the game engine. For example, after a user selects a location for fishing, a location display can be generated that includes a boat, the user's avatar, a fishing rod and other suitable features. As the user selects a target location to cast the user's lure or bait to, a graphic can be generated that displays the path for the cast and point of entry, for a cast that is accurate. While the user engages in this user interface or other suitable user interfaces, the camera angle for the display can be varied in response to the movement, and the 2D images can be relocated within the display to simulate a 3D environment, such as to simulate wave motion, wind, cloud motion or other suitable environmental variables.

Fish finder system 112 simulates a fish finder for use in a lake. In one exemplary embodiment, fish finder system 112 can have different models available for purchase by user, where more expensive models have more needed features, higher accuracy, fast response, and other suitable parameters. In this exemplary embodiment, fish finder system 112 can allow a user to select a target in a target display and can generate a display adjacent to the target display that slowly resolves to show underwater details, such as fish location, hazards or unknowns (fish or hazards) and depth. A higher-price fish finder unit can generate faster results and more accurate results, which creates an incentive for users to purchase the better fish finder if the amount of time that a user has is limited and if the objective of the game is to catch more fish within the allotted period of time. Each fish finder can also have an associated failure probability, where the less expensive models have a higher failure probability than the more expensive models, or other suitable features.

Tournament system 114 allows multiple players to participate in a tournament that involves a predetermined lake or location, a predetermined time limit, a predetermined limit on the types of fish to catch and other suitable parameters. In one exemplary embodiment, tournament system 114 can track start and finish times for tournaments, can track the different parameters for the tournament objectives (such as a list of current points in the tournament), can generate a schedule of future tournaments, and can track and generate other suitable tournament data.

Casting system 116 generates a user interface for simulating the casting of a fishing rod. In one exemplary embodiment, casting system 116 can create a first user interface for allowing the user to select a spot to target for the cast, and a second user interface for simulating aiming, casting power, casting accuracy, and other variables. Likewise, the user can also select different cast types, such as an overhead cast, a side arm cast, a pitch and skip cast and other suitable cast types, where each cast type has an associated minimum distance, flight path height, noise level and other parameters that must be strategically selected based on the selected target location and type of fish. In this exemplary embodiment, a target location for the cast can be selected that has underwater stumps that are under several nearby trees in the user interface and 40 meters out from the boat, such as for largemouth bass, which have a high probability of being 2 feet out from submerged stumps. If the user selects a casting style that generates a high level of noise, such as overhead, then the noise might cause the fish in the target location to be scared and to leave the target location, based on a probability associated with the fish leaving due to noise. Likewise, if the user selects a casting type that has a high flight path, the cast will have a higher probability of being caught in the nearby trees, based on a probability associated with the line snagging when the high casting style is selected and the presence or absence of trees. If the user selects a casting style that has a minimum distance that is more than 40 meters out, then the user will need to reel the lure through the fish's zone of sight or smell (depending on the bait/lure type), assuming that the fish is located in the vicinity of the underwater target that is 40 feet from the boat, and the user will also need to avoid snagging the lure on any underwater stumps as the user reels the lure in, which can be a function of a probability associated with a underwater hazard type, a lure type and a reeling speed. All of these factors have a strategic input into the casting type selected by the user, as well as other parameters. Casting system 116 can also interface with lake model system 110 to identify a track for a lure as it is reeled in, based on the location of the user's boat on a map and the location of the lure where it enters the water.

Casting system 116 can also generate a user interface for simulating the act of reeling in the lure after it has been cast. In one exemplary embodiment, the user interface can include an oscilloscope-type display that shows a waveform, where the magnitude and frequency of the waveform is a function of the speed at which the lure is being reeled in, the number and type of obstacles that the lure is moving past, currents, the reeling action of the user, the type of reel, rod, line and lure being used an other variables. The waveform display can have a plurality of locations for flares, where a flare can be a fish, a hazard, an indeterminate shape or other suitable shapes. If the user attempts to set the hook when a hazard is shown, then casting system 116 can determine whether the user's lure has become snared, based on a snare probability associated with the type of hazard, the speed at which the user is reeling in the lure, the lure type and other parameters. Likewise, if the user attempts to set the hook when a fish is shown, then casting system 116 can determine whether the user has hooked the fish based on a probability associated with the type of lure, the speed at which the user is reeling in the lure, a probability associated with the type of fish, a probability associated with a hunger level of the fish, a probability associated with an aggression level of the fish and other parameters.

Fish fight system 118 generates a user interface for simulating the act of bringing a fish into the boat after the fish has struck the lure and has been hooked. In one exemplary embodiment, fish fight system 118 can generate a user interface that displays a “tug of war” type icon, where a user wins the fight if the icon is moved to one side to a point at or beyond a first icon and where the user loses the fight if the icon is moved to the opposite side to a point at or beyond a second icon. The user interface can also display tactics available to the user (such as pulling the line, lifting the line towards the surface, momentarily releasing the line, stunning the fish, reeling smoothly and other tactics), the fish (hunker down, dive deep, reverse, break for it, full stop, bury into grass, go behind a rock, go behind a tree, serpentine, corkscrew, ramming speed, cross under, jump and other tactics), a countdown to the next fish tactic, and other suitable data. A user can attempt to counter a fish tactic, can apply a user tactic when a fish is not using a tactic or can otherwise strategically attempt to move the tug of war indicator to the user's side. A user can also use a consumable tactic, such as water, a power drink, a snack or other suitable consumables. Tactics can be one time use tactics, can be used as many times as desired, can be used once within a predetermined period of time or other suitable tactic usage parameters can be provided.

Lure retrieval system 120 models the probability of retrieving a lure that has become snagged. In one exemplary embodiment, lure retrieval system 120 can model a number of different parameters, such as the length of time required to retrieve the lure, the risk of damage to the lure, the risk of losing the lure and other parameters can be modeled for each incident. Each parameter can be modified based on the lure, the amount of damage previously done to the lure, the rod, the reel, the hazard type and other variables. In addition, a user can also have a skill level associated with a type of lure, a type of hazard or other variables that modifies the chance of success. If the user loses a lure, then the user can be presented with the option to purchase the lure at a discount from the cost of the lure at a bait shop.

Hazards system 122 allows one or more hazards to be modeled. In one exemplary embodiment, hazards can have different parameters, which can be modeled to allow users to more realistically interact with hazards. In this exemplary embodiment, each lure can have associated snag probabilities associated with hazard types, such as a medium probability of being snagged for reeds, a high probability for tree roots, a medium probability for tree stumps, a very high probability for tree branches, a low probability for grass, a high probability for rocks and other suitable probability indicators. Likewise, the speed at which the lure is moved through the hazard can also be applied as a parameter, such as where moving a lure at a high speed decreases the risk of getting snagged for certain hazards and increases the risk of getting snagged for other features. If the user is casting or reeling a lure through a hazards zone, then a hazards indicator can be shown to alert the user to the risk, so as to allow the user to attempt to avoid the hazard by relocating the boat, choosing a different target or in other manners. If a lure becomes snagged, then the user can be presented with the option of attempting to retrieve the lure or cutting the line. Each attempt to retrieve a lure can have an associated amount of time, where continued failure results in loss of remaining time to catch fish. In addition, retrieval of a lure can also result in additional damage to the lure, where the amount of damage is cumulative and can eventually result in failure of the lure. If the user elects to cut the line, the user can then retrieve a different rod and reel for use from a storage compartment of the boat if one is available, or can attach a new lure to the line (which can have an associated time penalty).

User interface systems 124A through 124N allow multiple players to interface with fishing game manager 102, such as for tournaments or other activities. Each user interface system 124A through 124N can be a smart telephone, a tablet computer, a laptop computer a desktop computer or other suitable devices, and can access fishing game manager 102 over a wireline network, a wireless network, other suitable communications media or a suitable combination of communications media.

Sponsor system 126 allows third parties, such as manufacturers of fishing gear, fishing guides, or other suitable persons, to sponsor events. In one exemplary embodiment, the sponsor can be charged a fee and can be allowed to select different types of advertising, such as in game advertising on every screen, in game advertising on leader boards, in game pop up advertising and other suitable advertising. The sponsor can also be allowed to offer prizes such as fishing gear, fishing guide trips or other suitable incentives.

In operation, system 100 allows various parameters of a fishing activity to be accurately modeled, so as to create a more engaging game that is more realistic and more challenging than prior art fishing games. System 100 provides interactive features to allow different players to communicate during the game and to increase the social networking aspect of the game.

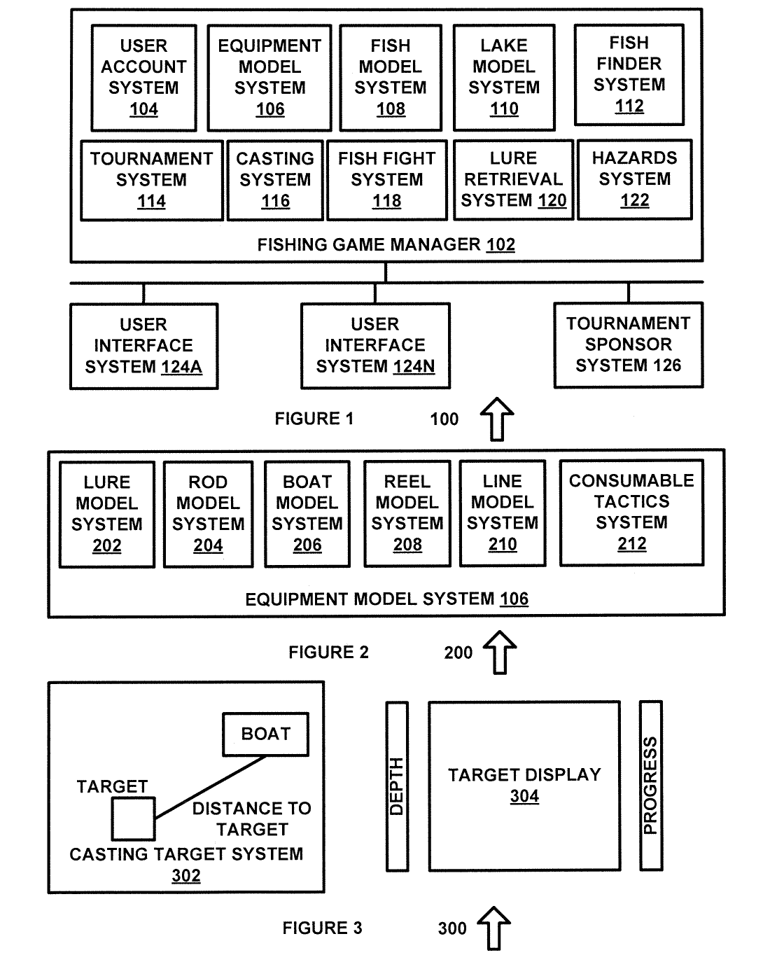

FIG. 2 is a diagram of a system 200 for modeling fishing equipment in accordance with an exemplary embodiment of the present disclosure. System 200 includes lure model system 202, rod model system 204, boat model system 206, reel model system 208, line model system 210 and consumable tactics system 212, each of which can be implemented hardware or suitable combination of hardware and software, and which can be one or more software systems operating on one more processors.

Lure model system 202 models parameters of lures, such as a fight power indicator that indicates the advantage that a player will have using the lure in a fight with a fish, a noise parameter that reflects an amount of noise generated by the lure, a casting range or range multiplier that reflects the ease or difficulty of casting the lure, a snag likelihood that indicates the chances of snagging the lure in different hazard types, a snag recovery percentage bonus indicator that indicates the difficulty or ease of retrieving the lure if it is snagged, a brightness indicator that indicates the relative brightness of the lure and other parameters. In one exemplary embodiment, fish model system 108 can include a variety of parameters for each different type of fish, such as whether the fish is attracted to noise or is repelled by noise, whether the fish is attracted to bright lures, a fight power of the fish, or other suitable parameters. In this exemplary embodiment, a player will try to select a lure that will not only catch the type of fish that the user is interested in, but will also try to avoid snagging the lure. Because lures will typically be installed on a rod prior to the game beginning (in order to save time during the game), the user must be prepared for different hazard types (trees, rocks, bushes, grass), which is also a strategic consideration in the selection of lures.

Rod model system 204 identifies a plurality of parameters available for different models of fishing rods. In one exemplary embodiment, a rod can have an associated power variable (where the sum of the fight powers for each component of the player's tackle setup (rod/reel/line/lure) is compared to the fish's fight power, plus any tactics used by the player or the fish, to determine whether the player or the fish wins a fish fight), a range variable (indicating a maximum range that the rod can be used for), tactic variables (for indicating one or more tactics that the rod can be used with), a level at which the rod is available, a cost, and other suitable parameters. In this exemplary embodiment, the rod parameters are combined with the reel parameters, the lure parameters and other suitable parameters to determine whether a fish is hooked, the lure gets snagged, the player wins or loses the fish fight and other game outcomes.

Boat model system 206 models parameters for boats, which can be purchased by players for different prices. In one exemplary embodiment, the boat can include a parameter for storage capacity (for a number of rod setups (rod, reel, line and lure) that can be stored, a number of consumables that can be stored), a parameter for speed (for the amount of game time it takes to travel a unit distance, to relocate the boat, to try to unsnag a line), a parameter for noise (which can result in less fish in a given location) and other suitable parameters. In this exemplary embodiment, the player can have a predetermined amount of time to fish for one round of the game or for a tournament, where a faster boat will allow the player to spend less time traveling to better fishing location, retrieving a snagged lure, or performing other activities. Likewise, a boat with more storage space can allow a player to store more rod setups on the boat, more lures and other equipment. In general, a faster boat with more storage space will cost more than a slower boat with less storage space.

Reel model system 208 models parameters for reels that are available for purchase by players and associated parameters for the reels. In one exemplary embodiment, a reel can have a fish fight power that indicates a power that can be used for a fish fight, a gear ratio that allows the player to control the speed of movement of the lure (where speed is a factor in determining whether a lure will be struck by a fish or snagged when moving through a hazard zone), attracting different types of fish (where fish are attracted to fast moving lures or where a lure needs to move at a certain speed to be effective) and other suitable parameters.

Line model system 210 allows a user to select different lines for use with the rod, reel and lure. In one exemplary embodiment, line model system 210 can model monofilament lines that float versus fluorine lines that sink, the weight of the line, a fish fighting power, the color of the line, a snag recovery bonus for line, and other features. For example, if a player uses a floating line with a sinking lure or a sinking line with a floating lure, then the effectiveness of the lure can be diminished by a predetermined percentage. Likewise, a line with a lower weight rating will be more likely to break during a fish fight, depending on the weight of the fish and the tactics used by the fish and the user.

Consumable tactic system 212 allows the user to purchase or acquire consumable tactics, such as energy drinks, lure scents or other consumable tactics. In one exemplary embodiment, a user can consume an energy drink during a fish fight to counter fish tactics, can use a consumable tactic to provide in-game award bonuses (such as currency or experience points) for a predetermined period of time, or can use other suitable consumable tactics.

In operation, system 200 allows parameters of fishing equipment to be modeled to match different lake environments, different fish, and other features. In this manner, a player can make strategic choices about which rods, reels lines and lures to use and which consumable tactics to acquire, based on the location where a user will be fishing in the game and other parameters.

FIG. 3 is a diagram of a user interface 300 for a fish finder display, in accordance with an exemplary embodiment of the present disclosure. User interface 300 can be implemented in hardware or a suitable combination of hardware and software, and can be one or more objects operating on a user interface, such as a touch screen controller, a screen display with a mouse control or other suitable user interfaces.

Display 300 includes casting target system 302 and target display system 304, each of which can be implemented as one or more objects that each have state and associated graphical, text, and functional attributes. Casting target system 302 generates a user display that shows a relative location of a boat and a target in a lake environment. In one exemplary embodiment, a user can place the target within the environment and can receive information regarding the distance between the boat and the target, whether the target is an allowed target, whether there are any hazards present in the vicinity of the target and other suitable data. Likewise, the user can also activate fish finder system 112 to populate target display 304. Target display 304 can require a predetermined or variable time to reach a resolution (such as based on environmental conditions), and the progress can be indicated by a progress meter adjacent to target display 304. Likewise, target display 304 can include a depth indicator, which can be used to estimate a depth at which one or more fish or one or more hazards are located. The data shown on target display 304 can include a symbol or symbols for fish, hazards, or unknowns (which can be either fish or hazards). A more expensive fish finder can result in faster target resolution (with less time deducted from the allotted game period), a more accurate target resolution (with more fish and hazards detected and less unknown indications), and other suitable features.

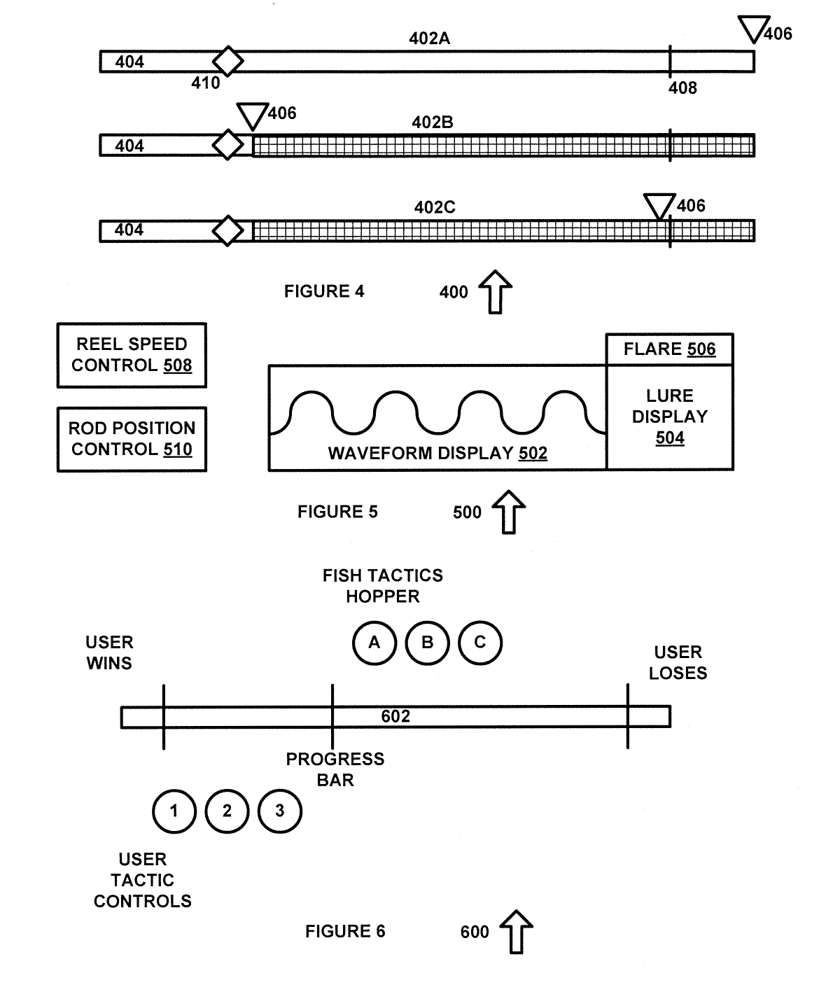

FIG. 4 is a diagram of a user interface 400 for casting in accordance with an exemplary embodiment of the present disclosure. User interface 400 includes a casting status bar 404, which is shown in a start position in display 402A. In the start position, a progress indicator 406 is also in a start location at the far right hand side of the casting status bar. In addition, target power indicator 410 and accuracy indicator 408 are used to indicate the points at which the user should activate a user interface control, such as by clicking on a mouse, entering a keyboard selection, touching a touchscreen or in other suitable manners. In display 402B, the user has actuated a casting control, such as by making a selection with a mouse button or other suitable controls, to cause progress indicator 406 to move from the start position shown in 402A towards the left to the position shown in 402B, where progress indicator 406 is next to the target power indicator 410. By stopping progress indicator 406 close to target power indicator 410, the user will provide sufficient casting power for the lure to land at a distance approximately equal to the distance to the target. Alternatively, if the user were to undershoot or overshoot target power indicator 410, the cast will go long or short of the target.

The user then enters another user command (mouse click, keyboard entry, touch screen controller tap) to stop the progress of progress indicator 406 from moving from the right to the left, and to start the movement of progress indicator from the left to the right. In 402C, the progress indicator has moved to a position adjacent to target accuracy indicator 408, and by actuating the control again at this point, the user will cast the lure to a position near or on the target location. Alternatively, if the user were to miss the target accuracy indicator, then the cast will land a corresponding distance away from the target, and potentially get snared in a hazard, such as tree branches.

In operation, user interface 400 allows the casting action of fishing to be simulated, in that a user must not only accurately estimate the power needed to place the lure near a target, but must also provide the accuracy needed to place the lure near the target. A separate display system, such as casting target system 302, can generate an animated sequence that shows the effects of the cast, such as a user moving a rod in an overhead cast, a side arm cast, a pitch and skip cast or other selected casts, and the lure traveling through the air with a distance and accuracy reflected by the user's interaction with user interface 400. In one exemplary embodiment, a series of stored animation sequences can be used, a rendering algorithm can be implemented to show the movement of a cast lure with a trailing fishing line, or other suitable processes can also or alternatively be used.

FIG. 5 is a diagram of a lure display 500, in accordance with an exemplary embodiment the present disclosure. Lure display 500 can be implemented in hardware or a suitable combination of hardware and software, and can be one or more objects that each have state and associated graphical, textual and functional attributes, or other suitable user interface algorithms.

Display 500 simulates the action of reeling in a lure after it has been cast and prior to when the user sets the hook after the fish bites the lure. Display 500 includes waveform display 502, lure display 504, flare 506, reel speed control 506 and rod pull control 508. Waveform display 502 includes a sinusoidal waveform display that simulates the vibrations on the fishing line that occur as the lure is reeled towards the user in the boat. In the exemplary embodiment shown, a simple sinusoidal waveform is represented, but additional higher-frequency components can also or alternatively be provided, such as to simulate the lure moving through grass or weeds, different water conditions, nearby fish activity, or other suitable parameters.

In addition, waveform display 502 can indicate when a fish may have bit the line, when a line has become snagged, or other suitable situations. In one exemplary embodiment, a user can reel a cast lure in using one or more controls, such as to control the speed at which the lure is being reeled in. During that process, flare 506 can show a fish, a hazard or other suitable images. If the user tries to set the hook when a hazard waveform is shown, then there is a chance that the hook will become snagged, and waveform display 502 flattens out (likewise, if the user stops reeling the line, waveform display 502 will flatten out). Alternatively, if the user sets the hook when a waveform signifying a fish is shown, then the user will have a chance to hook the fish, after which a fish fighting user interface is generated. The length of time that the fish waveform is shown can be brief, to create an incentive for the user to act quickly when a fish waveform is shown, which can increase the chance that a user will mistakenly attempt to set the hook when a hazard is shown, which can lead to a snag.

Reel speed control 508 allows a user to control a speed at which the reel is simulated to be activated at. In one exemplary embodiment, reel speed control 508 can be implemented as one or more objects, each having state and associated graphic, text and functional attributes that allow a user to interface with reel speed control 508, such as by using a touch screen interface a keyboard, a mouse or other suitable interface devices. The user can increase, decrease or stop a simulated reel speed, such as by incrementally increasing or decreasing a current speed (such as by selecting a “+” or “−” indicator or key), by moving a slider control in a direction that is associated with increasing or decreasing a speed, or in other suitable manners. In response to user control of reel speed, a simulator that models the probability of snagging can be modified, such as 1) a probability of snagging when a first type of lure is moved through a first type of hazard is increased with increasing speed and decreased with decreasing speed, 2) a probability of snagging when the first type of lure is moved through a second type of hazard is decreased with increasing speed and increased with decreasing speed, 3) a probability of snagging when a second type of lure is moved through the first type of hazard is decreased with increasing speed and increased with decreasing speed, 4) a probability of snagging when the second type of lure is moved through the second type of hazard is increased with increasing speed and decreased with decreasing speed, or other suitable models. In addition, a simulator that models the probability of a fish strike can be modified, such as 1) a probability of strike when a first type of lure is moved near a first type of fish is increased with increasing speed and decreased with decreasing speed, 2) a probability of strike when the first type of lure is moved near a second type of fish is decreased with increasing speed and increased with decreasing speed, 3) a probability of strike when a second type of lure is moved near the first type of fish is decreased with increasing speed and increased with decreasing speed, 4) a probability of strike when the second type of lure is moved near the second type of fish is increased with increasing speed and decreased with decreasing speed, or other suitable models. In this manner, the effect of changing reeling speed can be modeled for purposes of simulating an actual fishing experience.

Rod position control 510 allows a user to control a rod position to simulate a response to game inputs. In one exemplary embodiment, rod position control 510 can be implemented as one or more objects, each having state and associated graphic, text and functional attributes that allow a user to interface with rod position control 510, such as by using a touch screen interface a keyboard, a mouse or other suitable interface devices. The user can move the rod back slowly, move the rod back sharply, move the rod from side to side, hold the rod still or otherwise move the rod, such as by incrementally increasing or decreasing a rod position control (such as by selecting a “+” or “−” indicator or key), by moving a slider control in a direction that is associated with a rod location, or in other suitable manners. In response to user control of rod position, a simulator that models the probability of snagging can be modified, such as 1) a probability of snagging when a first type of lure is moved through a first type of hazard is increased with increasing rod motion and decreased with decreasing rod motion, 2) a probability of snagging when the first type of lure is moved through a second type of hazard is decreased with increasing rod motion and increased with decreasing rod motion, 3) a probability of snagging when a second type of lure is moved through the first type of hazard is decreased with increasing rod motion and increased with decreasing rod motion, 4) a probability of snagging when the second type of lure is moved through the second type of hazard is increased with increasing rod motion and decreased with decreasing rod motion, or other suitable models. In addition, a simulator that models the probability of setting a hook after a fish bites can be modified, such as 1) a probability of setting when a first type of lure is bit by a first type of fish is increased with increasing rod motion and decreased with decreasing rod motion, 2) a probability of setting when the first type of lure is bit by a second type of fish is decreased with increasing rod motion and increased with decreasing rod motion, 3) a probability of setting when a second type of lure is bit by the first type of fish is decreased with increasing rod motion and increased with decreasing rod motion, 4) a probability of setting when the second type of lure is bit by the second type of fish is increased with increasing rod motion and decreased with decreasing rod motion, or other suitable models. In this manner, the effect of changing rod position can be modeled for purposes of simulating an actual fishing experience.

FIG. 6 is a diagram of a user interface 600 for use with a fish fight, in accordance with an exemplary embodiment of the present disclosure. User interface 600 can be implemented in hardware or a suitable combination of hardware and software, and can be one or more objects having state and associated text, graphical and functional attributes.

User interface 600 can be activated when a hook is successfully set in a fish, and includes a progress bar icon that is disposed along a “tug-of-war” style status bar 602. The user wins if the progress bar reaches the left-hand side of status bar 602, where USER WINS is shown, and the user loses if the progress bar reaches the right-hand side of status bar 602, where USER LOSES is shown. The direction that the progress bar initially moves in as well as the speed at which it moves can be determined by the difference between the fish's power and the combined power of the user's tackle (rod, reel, line and lure), fish tactics, user tactics or other suitable factors. Depending on the direction and magnitude of the difference, the progress bar may move quickly or slowly towards either side.

As the user reels in the fish, user tactic controls 1, 2 or 3 can be actuated by the user to try and move the progress bar towards USER WINS or towards USER WINS. Likewise, the fish will also use tactics which are shown in the fish tactics hopper. The fish tactics A, B, C are not identified until they are used. The user tactic controls 1, 2, 3 can be selected to counter fish tactics in an attempt to try and win the fight by moving the progress bar to the USER WINS area. The number of user tactics and fish tactics can vary as a function of the experience level or equipment of the user, the size and aggressiveness of the fish, or other suitable variables.

In addition, the probability of the line breaking can be determined, based on the fish's weight, power, the tactics used by the user and the fish or other suitable variables. In this manner, it is possible for a user with a light line to land a large/heavy fish, depending on the tactics used by the user and the fish, as well as the timing of those tactics.

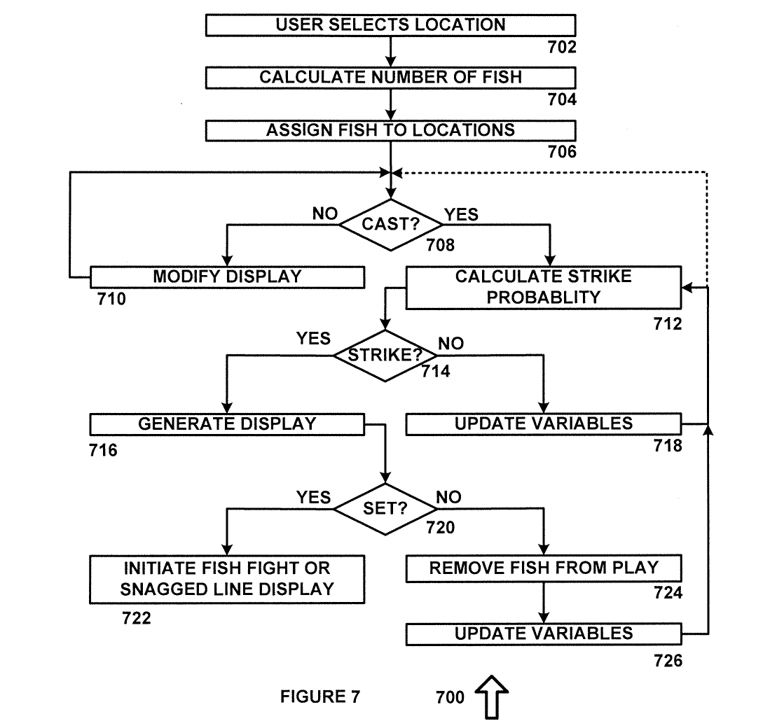

FIG. 7 is a diagram of an algorithm 700 for simulating fish artificial intelligence in accordance with an exemplary embodiment of the present disclosure. Algorithm 700 can be implemented in hardware or a suitable combination of hardware and software, and can be one or more software systems operating on one or more processors.

Algorithm 700 begins at 702, where a user selects a location. In one exemplary embodiment, the user can use a map user interface to select a location along the shore of a lake or other bodies of water, and a travel time to travel to the selected location can be calculated and deducted from a game clock. The algorithm then proceeds to 704.

At 704, a number of fish for the location is calculated. In one exemplary embodiment, the number of fish can be determined as a function of environmental factors, such as a season, a water temperature, weather conditions, cloud cover, wind, water clarity, barometric pressure or other suitable variables, and which can be correlated to actual conditions at a lake that is being modeled. The algorithm then proceeds to 706.

At 706, each of the calculated fish are assigned to a specific coordinate within the selected location. In one exemplary embodiment, a specific coordinate for a fish can be based on fish preferences for certain locations (such as depth, availability of cover), fish preferences for certain environmental conditions (such as sun, rain, cloud cover or wind), or other suitable factors. The algorithm then proceeds to 708.

At 708, it is determined whether a user has activated a casting control. In one exemplary embodiment, the casting control can be generated on a user interface such as a touch screen interface or other suitable device using one or more objects, each having state and graphical, text and functional attributes and which generates a user-selectable control to simulate a casting maneuver, such as by generating an animated sequence in which an avatar moves a fishing rod in a casting manner and a lure is simulated moving through the air to a spot on the surface of the lake or other body of water. If the user has activated the casting control, the algorithm proceeds to 712, otherwise the algorithm proceeds to 710 where the user interface display is modified. In one exemplary embodiment, the user interface display can be modified to simulate the movement of clouds, wind on the surface of the lake or other body of water, or other suitable motion. In addition, variables associated with the environmental factors (increase or decrease in sunlight, increase or decrease in wind) can be adjusted, and the algorithm returns to 708.

At 712, a strike probability is calculated. In one exemplary embodiment, a fish can have an associated strike probability that is a function of the distance between the fish and the lure, the season, the water temperature, weather conditions, cloud cover, wind, water clarity, barometric pressure, the type of tackle being used (lure, rod, reel, line), or other suitable factors. The algorithm then proceeds to 714 where it is determined whether a fish has struck. In one exemplary embodiment, a random number generator can be used to generate a number that is compared to the probability of the fish strike. If it is determined that a strike has occurred (such as if the number falls within the fish strike probability), the algorithm proceeds to 716, otherwise the algorithm proceeds to 718, where variables are updated. In one exemplary embodiment, the probability of a strike can be calculated as a function of the location of the lure (such as for every change in position of one foot), as a function of time (such as once every X seconds) or in other suitable manners, and where any changing environmental factors are updated for the new calculation. The algorithm then returns to 712 (if the user has not reeled the lure all the way back) or to 708 (if the user has reeled the lure back and has to cast again).

At 716, a display is generated that indicates that a strike may have occurred. In one exemplary embodiment, the display can include a variety of waveform-like components that simulate vibrations on a fishing line, where different points along the line will have peaks associated with fish strikes, hazards, wind, current or other environmental features. The algorithm then proceeds to 720, where it is determined whether a user has set the hook. In one exemplary embodiment, a user can activate a control that is configured to cause a hook-setting process to be modeled, such as by generating an animation sequence that shows the user's avatar moving the user's fishing rod backwards in a rapid motion and accompanying line movements, and by determining whether a fish or hazard is in the vicinity of the user's lure. If it is determined that the user has set the hook (fish) or that the line has snagged (hazard), the algorithm proceeds to 722, where a fish fight display or a snagged hook display is generated with associated user controls. If it is determined that the hook has not been set, the algorithm proceeds to 724 where the fish is removed from play. The algorithm then proceeds to 726 where environmental variables are updated, and the algorithm returns to 712 if the lure has not been reeled completely back, or to 708 otherwise.

In operation, algorithm 700 allows a user to simulate a fishing experience by allowing a user to select a location, by populating the location with fish based environmental factors and other variables, by allowing the user to select a target location and to simulate casting to that location, by allowing the user to simulate reeling a lure and setting the lure if a fish strikes, and to simulate a fish fight. Although algorithm 700 is shown as a flow chart, a state diagram, object oriented programming techniques or other suitable paradigms can also or alternatively be used to implement algorithm 700.

In one exemplary embodiment, fish artificial intelligence can be implemented using a model that includes mathematical probabilities that interact with the game elements to simulate the likelihood of hooking a fish, tactics that the fish will dynamically and randomly implement to try and evade capture after being hooked, how those tactics are used by the fish, and other game aspects. In this exemplary embodiment, the fish artificial intelligence can be implemented with a user interface that allows an administrator or other suitable user to view the algorithms and metrics, so as to change factors to increase or lessen the chances for a user to land a fish. These probabilities can be used to model the effect of environmental factors, location types (deep vs shallow water, near structures, covered vs open), and can be given a score that is configurable in the user interface. Additionally, each fish type can have associated preferences for different location types. These scores and preferences can be used to determine where the fish are more likely to populate when the fish are generated for a selected fishing location. Environmental factors can include season, water temperature, weather changes, cloud cover, wind, water clarity, barometric pressure and other suitable factors. User selectable factors include the lure/bait type, the casting method, the retrieval method and the line type.

Mathematical formulas contain factors that interact with each other that provide a dynamic and changing set of conditions that impact success. For example, when populating a lake spot, each section of the lake is assigned a number of points which represent the likelihood that fish will populate in that area. For each section of lake, population points can be set based a sum of environmental factors and location factors. For example, a selected location may have an area of 1000 square meters, and a calculated number of fish for that area can be 18. Each fish can then be placed within the 1000 square meter area, with a preference for placement being assigned for locations where the fish has a preference (such as near a tree or stump, in deep water, in grass and so forth). After the fish have been semi-randomly placed within the selected location, the user can be allowed to select a target, to cast the lure/bait and to reel in the cast lure/bait. As the user reels the lure/bait near a fish (such as after a predetermined distance that the lure/bait travels or after a predetermined period of time), a chance of a strike can be calculated, where the chance is based on the distance of each fish to the lure, environmental factors that make a fish more or less likely to strike a lure, user selections that make a fish more or less likely to strike, bonus multipliers and other suitable factors. For example, a user can have an associated skill level that is based on an average number of fish caught per trip, a percentage of casts that are perfect, statistics for a number of catches per cast, a number of trips completed since last tier advance or other suitable factors, and these factors can also increase or decrease the chance of a strike.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A multiplayer fishing game with a waveform user interface, comprising:
a processor;
a user interface device coupled to the processor and configured to generate user-selectable controls in response to data received from the processor; and
a lure user interface operating on the user interface device and the processor, the lure user interface having a waveform display for simulating a waveform on a fishing line as a lure is moved through water and one or more indicators to simulate a fish and a hazard interacting with the lure; and
wherein the lure user interface is responsive to a user control to model a response by the fish and a response by the hazard to the user control.

2. The multiplayer fishing game of claim 1 wherein the user control comprises a reel speed control configured to receive a user input and to increase or decrease a simulated reel speed in response to the user input.

3. The multiplayer fishing game of claim 1 wherein the user control comprises a rod position control configured to receive a user input and to modify a simulated rod position in response to the user input.

4. The multiplayer fishing game of claim 1 further comprising a lure display configured to display an image of a lure adjacent to the waveform display.

5. The multiplayer fishing game of claim 1 further comprising a flare display configured to display an image of a fish, a hazard and an indeterminate object adjacent to the waveform display.

6. The multiplayer fishing game of claim 1 further comprising a lure model system configured to generate a plurality of lures, each lure having an associated cost and one or more of a noise parameter that reflects an amount of noise generated by the lure, a casting range or range multiplier that reflects the ease or difficulty of casting the lure, a snag likelihood that indicates the chances of snagging the lure in different hazard types, a snag recovery percentage bonus indicator that indicates the difficulty or ease of retrieving the lure if it is snagged or a brightness indicator that indicates the relative brightness of the lure.

7. The multiplayer fishing game of claim 1 further comprising a lure retrieval system configured to model a probability of retrieving a lure that has become snagged as a function of one or more of a length of time required to retrieve the lure, a risk of damage to the lure and a risk of losing the lure.

8. The multiplayer fishing game of claim 7 wherein the probability of retrieving the lure for one or more of the length of time required to retrieve the lure, the risk of damage to the lure and the risk of losing the lure is modified based on the lure, the amount of damage previously done to a lure selected by the user, a rod selected by the user, a reel selected by the user and a hazard type.

9. The multiplayer fishing game of claim 7 wherein the probability of retrieving the lure for one or more of the length of time required to retrieve the lure, the risk of damage to the lure and the risk of losing the lure is modified based on a user skill level associated with a type of lure or a user skill level with a type of hazard.

10. The multiplayer fishing game of claim 1 further comprising a hazards system configured to provide a probability of the lure being snagged for reeds, a probability of the lure being snagged for tree roots, a probability of the lure being snagged for tree stumps, a probability of the lure being snagged for tree branches, a probability of the lure being snagged for grass and a probability of the lure being snagged for rocks.

11. A method for providing a multiplayer fishing game with a waveform user interface, comprising:
generating a waveform display on a user interface device using a processor;
modifying a waveform on the waveform display to simulate a fishing line as a lure attached to the fishing line is moved through water;
modifying the waveform on the waveform display to simulate a fish interacting with the lure;
modifying the waveform on the waveform display to simulate a hazard interacting with the lure;
receiving a user-entered response to the modification of the waveform; and
modeling a response by the fish and a response by the hazard to the user-entered response.

12. The method of claim 11 further comprising:
receiving a user input to increase or decrease a simulated reel speed; and
modeling a response to the user input.

13. The method of claim 11 further comprising:
receiving a user input to modify a simulated rod position; and
modeling a response to the user input.

14. The method of claim 11 further comprising displaying an image of a lure adjacent to the waveform display.

15. The method of claim 11 further comprising displaying an image of one or more of a fish, a hazard and an indeterminate object adjacent to the waveform display.

16. The method of claim 11 further comprising generating a user interface display of plurality of lures, each lure having an associated cost and one or more of a noise parameter that reflects an amount of noise generated by the lure, a casting range or range multiplier that reflects the ease or difficulty of casting the lure, a snag likelihood that indicates the chances of snagging the lure in different hazard types, a snag recovery percentage bonus indicator that indicates the difficulty or ease of retrieving the lure if it is snagged or a brightness indicator that indicates the relative brightness of the lure.

17. The method of claim 11 further comprising modeling a probability of retrieving a lure that has become snagged as a function of one or more of a length of time required to retrieve the lure, a risk of damage to the lure and a risk of losing the lure.

18. The method of claim 17 wherein the probability of retrieving the lure for one or more of the length of time required to retrieve the lure, the risk of damage to the lure and the risk of losing the lure is modified based on the lure, the amount of damage previously done to a lure selected by the user, a rod selected by the user, a reel selected by the user and a hazard type.

19. The method of claim 17 wherein the probability of retrieving the lure for one or more of the length of time required to retrieve the lure, the risk of damage to the lure and the risk of losing the lure is modified based on a user skill level associated with a type of lure or a user skill level with a type of hazard.

20. In a multiplayer fishing game having a processor, a user interface device coupled to the processor and configured to generate user-selectable controls in response to data received from the processor, a lure user interface operating on the user interface device and the processor, the lure user interface having a waveform display for simulating a waveform on a fishing line as a lure is moved through water and one or more indicators to simulate a fish and a hazard interacting with the lure, wherein the lure user interface is responsive to a user control to model a response by the fish and a response by the hazard to the user control, wherein the user control comprises a reel speed control configured to receive a user input and to increase or decrease a simulated reel speed in response to the user input, wherein the user control comprises a rod position control configured to receive a user input and to modify a simulated rod position in response to the user input, a lure display configured to display an image of a lure adjacent to the waveform display, a flare display configured to display an image of a fish, a hazard and an indeterminate object adjacent to the waveform display, a lure model system configured to generate a plurality of lures, each lure having an associated cost and one or more of a noise parameter that reflects an amount of noise generated by the lure, a casting range or range multiplier that reflects the ease or difficulty of casting the lure, a snag likelihood that indicates the chances of snagging the lure in different hazard types, a snag recovery percentage bonus indicator that indicates the difficulty or ease of retrieving the lure if it is snagged or a brightness indicator that indicates the relative brightness of the lure, a lure retrieval system configured to model a probability of retrieving a lure that has become snagged as a function of one or more of a length of time required to retrieve the lure, a risk of damage to the lure and a risk of losing the lure, wherein the probability of retrieving the lure for one or more of the length of time required to retrieve the lure, the risk of damage to the lure and the risk of losing the lure is modified based on the lure, the amount of damage previously done to a lure selected by the user, a rod selected by the user, a reel selected by the user and a hazard type, wherein the probability of retrieving the lure for one or more of the length of time required to retrieve the lure, the risk of damage to the lure and the risk of losing the lure is modified based on a user skill level associated with a type of lure or a user skill level with a type of hazard, and a hazards system configured to provide a probability of the lure being snagged for reeds, a probability of the lure being snagged for tree roots, a probability of the lure being snagged for tree stumps, a probability of the lure being snagged for tree branches, a probability of the lure being snagged for grass and a probability of the lure being snagged for rocks, a method comprising:
generating the waveform display on the user interface device using a processor;
modifying the waveform on the waveform display to simulate the fishing line as the lure attached to the fishing line is moved through water;
modifying the waveform on the waveform display to simulate the fish interacting with the lure;
modifying the waveform on the waveform display to simulate the hazard interacting with the lure;
receiving the user-entered response to the modification of the waveform;
modeling the response by the fish and the response by the hazard to the user-entered response;
receiving the user input to increase or decrease the simulated reel speed;
modeling the response to the user input;
receiving the user input to modify the simulated rod position;
modeling the response to the user input;
displaying an image of a lure adjacent to the waveform display;
displaying an image of one or more of a fish, a hazard and an indeterminate object adjacent to the waveform display;
generating a user interface display of plurality of lures, each lure having an associated cost and one or more of a noise parameter that reflects an amount of noise generated by the lure, a casting range or range multiplier that reflects the ease or difficulty of casting the lure, a snag likelihood that indicates the chances of snagging the lure in different hazard types, a snag recovery percentage bonus indicator that indicates the difficulty or ease of retrieving the lure if it is snagged or a brightness indicator that indicates the relative brightness of the lure;
modeling a probability of retrieving a lure that has become snagged as a function of one or more of a length of time required to retrieve the lure, a risk of damage to the lure and a risk of losing the lure,
wherein the probability of retrieving the lure for one or more of the length of time required to retrieve the lure, the risk of damage to the lure and the risk of losing the lure is modified based on the lure, the amount of damage previously done to a lure selected by the user, a rod selected by the user, a reel selected by the user and a hazard type; and
wherein the probability of retrieving the lure for one or more of the length of time required to retrieve the lure, the risk of damage to the lure and the risk of losing the lure is modified based on a user skill level associated with a type of lure or a user skill level with a type of hazard.
